(19) United States
(12) Patent Application Publication
(10) Pub. No.: US 2010/0187376 A1
(43) Pub. Date: Jul. 29, 2010

(54) ADJUSTABLE APPARATUS AND THE DISPLAY DEVICE HAVING THE ADJUSTABLE APPARATUS

(76) Inventor: Yung-Chun SU, Sinjhuang City (TW)

Correspondence Address: BIRCH STEWART KOLASCH & BIRCH, PO BOX 747, FALLS CHURCH, VA, 22040-0747, US

(21) Appl. No.: 12/692,022

(22) Filed: Jan. 22, 2010

(30) Foreign Application Priority Data
Jan. 23, 2009 (TW) 098102970

(51) Int. Cl. F16M 11/38

(52) U.S. Cl. 248/157

(57) ABSTRACT

The present invention discloses a height-adjustable apparatus and a display device having the height-adjustable apparatus. The height-adjustable apparatus comprises a connector, a base and a supporting unit, wherein a flat display panel can be connected to the connector while the base is connected to or disposed on a plane. The supporting unit comprises a first cover and a second cover respectively connected to the connector and the base to form a four-bar linkage. The first cover and the second cover are made of plastic material and respectively include ribs on their inner surfaces for increasing the structural strength of the assembled first cover and second cover.

### BACKGROUND OF THE INVENTION

1. Field of the Invention

The present invention relates to a height-adjustable apparatus and a display device having the height-adjustable apparatus, specifically to a height-adjustable apparatus including plastic covers and a display device having the height-adjustable apparatus.

2. Description of the Prior Art

The flat display includes a flat display panel for displaying images and a height-adjustable apparatus for supporting the flat display panel and adjusting the height of the flat display panel. FIG. 1 is a schematic view of a conventional height-adjustable apparatus 10, wherein the conventional height-adjustable apparatus 10 includes a base 11 and a connector 12 to be coupled to the flat display panel. Furthermore, the conventional height-adjustable apparatus 10 further includes a linkage element 16, wherein the linkage element 16 includes a first linkage member 13 and a second linkage member 14. Two ends of the first linkage member 13 and those of the second linkage member 14 are coupled to the base 11 and the connector 12, respectively, to form a four-bar linkage structure and allow the connector 12 to move vertically. However, the above-mentioned linkage element 16 is made of metals to ensure the strength of the linkage element 16 but the use of metal also increases the material cost. Furthermore, the metallic linkage element 16 is originally an iron sheet which requires processes such as stamping, bending, etc. to achieve the desired structure. The additional manufacture processes for the linkage element 16 increase the manufacture cost of the conventional height-adjustable apparatus 10 and the overall manufacture cost of the associated display device.

### SUMMARY OF THE INVENTION

It is an object of the present invention to provide a height-adjustable apparatus for supporting a display panel and allowing the display panel to move perpendicularly and linearly.

It is another object of the present invention to provide a height-adjustable apparatus having simpler manufacture processes and lower manufacture cost.

It is yet another object of the present invention to provide a display device having the above-mentioned height-adjustable apparatus, which has a simplified structure and lower manufacture cost.

The height-adjustable apparatus includes a connector, a base and a supporting unit, wherein the supporting unit has a first cover and a second cover. Two ends of the supporting unit are connected to the connector and the base respectively. The connector is coupled with a flat display panel such as a liquid crystal display panel while the base is attached to or fixed on a plane such as a tabletop.

The first cover and the second cover are made of plastic material, wherein the plastic material includes material having extensibility greater than 5% such as polyvinyl chloride or other suitable materials. In one embodiment, the first cover and the second cover are made by injection molding, but are not limited thereto. In different embodiments, the first cover and the second cover can be manufactured by other molding methods.

Edges of the first cover and the second cover are disposed with a first curved portion and a second curved portion respectively, wherein a space is formed between the assembled first cover and second cover and enclosed by the first curved portion and the second curved portion. A first rib and a second rib are disposed on the inner surface of the first cover and that of the second cover, respectively, for enhancing the structural strength of the first cover and the second cover. Furthermore, a first reinforcing rib and a second reinforcing rib are disposed on the inner surface of the first cover and that of the second cover, respectively. The first reinforcing rib and the second reinforcing rib are perpendicularly connected to the first rib and the second rib, respectively, but are not limited thereto. In different embodiments, two ends of the first reinforcing rib can be connected to the first rib and the first curved portion. Similarly, two ends of the second reinforcing rib can be connected to the second rib and the second curved portion.

In different embodiments, the height-adjustable apparatus includes a first main cover and a second main cover, wherein the first main cover includes a first sub-cover and a second sub-cover. The second main cover includes a third sub-cover and a fourth sub-cover. A first gap is kept between the first sub-cover and the second sub-cover while the first sub-cover and the second sub-cover are symmetrical to each other. In this way, the use of plastic material for the first main cover to reduce the overall manufacture cost. Similarly, the third sub-cover and the fourth sub-cover are separately formed so that the use of plastic material for making the second main cover reduces the overall manufacture costs.

### BRIEF DESCRIPTION OF THE DRAWINGS

FIG. 1 is a schematic view of a conventional height-adjustable apparatus;

FIG. 2A and FIG. 2B are respectively a side view and a schematic view of the height-adjustable apparatus of the present invention;

FIG. 3 is a side view of the display device of the present invention;

FIG. 4A and FIG. 4B are respectively a side view and a top view of the height-adjustable apparatus of the present invention, wherein the first cover is separated from the second cover;

FIG. 5 is a schematic view of the first cover of the present invention;

FIG. 6 is a schematic view of the second cover of the present invention;

FIG. 7 is partial cross-sectional view of the height-adjustable apparatus;

FIG. 8A and FIG. 8B are a top view and a side view illustrating another embodiment of the height-adjustable apparatus of the present invention;

FIG. 9 is a schematic view illustrating another embodiment of the height-adjustable apparatus of the present invention;

FIG. 10 is a schematic view illustrating the first sub-cover and the second sub-cover in FIG. 8A and FIG. 8B; and

FIG. 11 is a schematic view illustrating the third sub-cover and the fourth sub-cover in FIG. 8A and FIG. 8B.

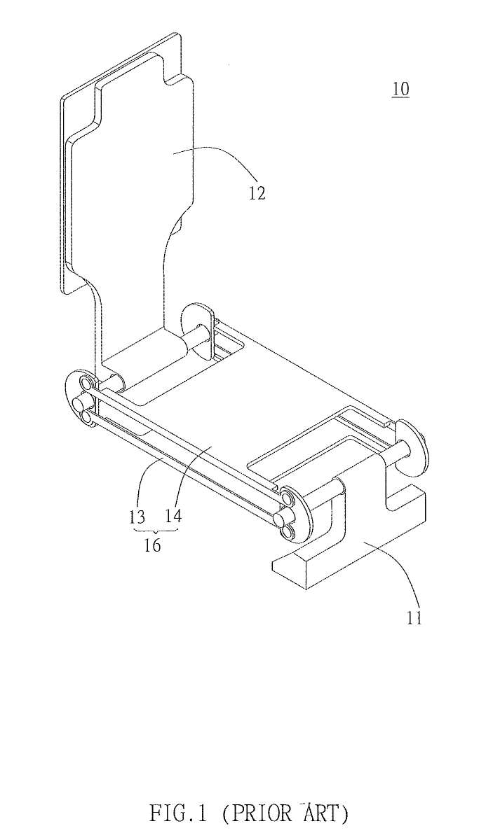

### DETAILED DESCRIPTION OF THE PREFERRED EMBODIMENT

The present invention provides a height-adjustable apparatus and a display device having the height-adjustable apparatus. The height-adjustable apparatus is used to support an object and allows the object to move in direction perpendicular to a plane. In the embodiments described below, the height-adjustable apparatus is used to support a liquid crystal (LC) display panel, but is not limited thereto; in different embodiments, the height-adjustable apparatus can be used to support other types of display panels such as organic light emitting diode (OLED) display panel.

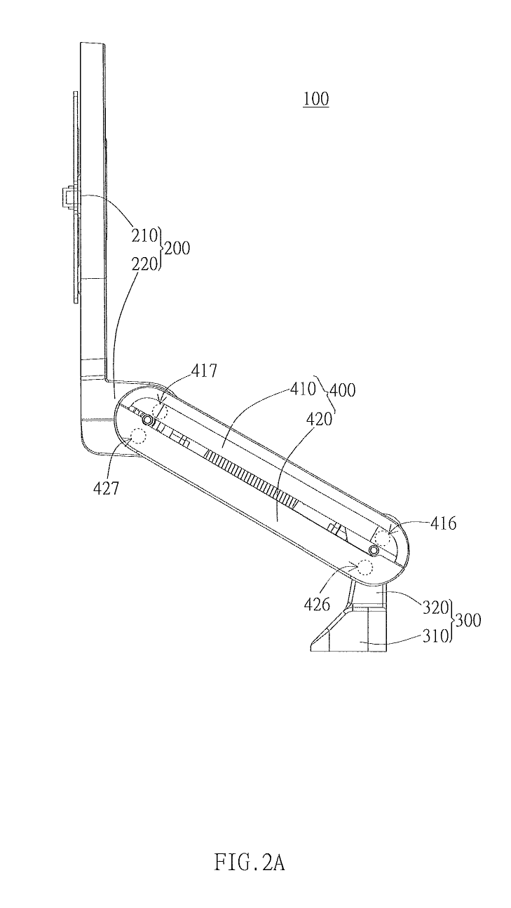

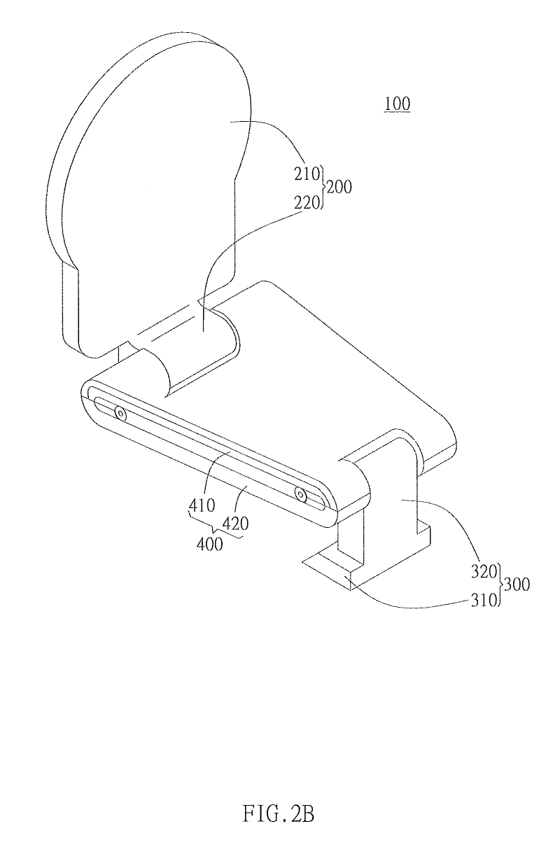

FIG. 2A and FIG. 2B are respectively a side view and a schematic view of the height-adjustable apparatus 100 of the present invention. As FIG. 2A and FIG. 2B show, the height-adjustable apparatus 100 includes a connector 200, a base 300, and a supporting unit 400, wherein the supporting unit 400 further includes a first cover 410 and a second cover 420. The first cover 410 and the second cover 420 are combined to form a space therein for accommodating other elements. In the present embodiment, the connector 200 includes a connecting portion 210, wherein the display panel such as a LC display panel or an OLED display panel is disposed on the connecting portion 210. The base 300 includes a base disposition end 310 to be fixed on planes such as a table top for fixing the height-adjustable apparatus 100 on the plane, but is not limited thereto; in different embodiments, the dimension of the base disposition end 310 can be modified according to design requirements for the height-adjustable apparatus 100 to be placed on a plane.

The connector 200 and the base 300 further include a connector coupling portion 220 and a base coupling portion 320, respectively. A plurality of openings are formed on the inner surfaces of the first cover 410 and the second cover 420 for coupling with the connector coupling portion 220 and the base coupling portion 320. The first cover 410 includes a first coupling portion 416 and a second coupling portion 417 formed on the inner surface and two opposite ends of the first cover 410. The second cover 420 includes a third coupling portion 426 and the fourth coupling portion 427 formed on the inner surface and two opposite ends of the second cover 420. In the present embodiment, the connector coupling portion 220 is pivotally connected to the second coupling portion 417 and the fourth coupling portion 427 while the base coupling portion 320 is pivotally connected to the first coupling portion 416 and the third coupling portion 426. In other words, the first cover 410 and the second cover 420 form a four-bar linkage and move in parallel with each other based on the movement of the connector 200 and the base 300. Thus if the base 300 is fixed on a table top and an external force is applied on the connector 200, the connector 200 can move linearly in relation to the supporting element 300.

Furthermore, in the embodiment illustrated in FIG. 2A and the FIG. 2B, the first cover 410 and the second cover 420 of the supporting unit 400 are made of plastic material, wherein the above-mentioned plastic material includes material with extensibility greater than 5% such as polyvinyl chloride or other suitable materials. In the present embodiment, the first cover 410 and the second cover 420 are manufactured by injection molding, but are not limited thereto; in different embodiments, the first cover 410 and the second cover 420 can be manufactured by other molding methods.

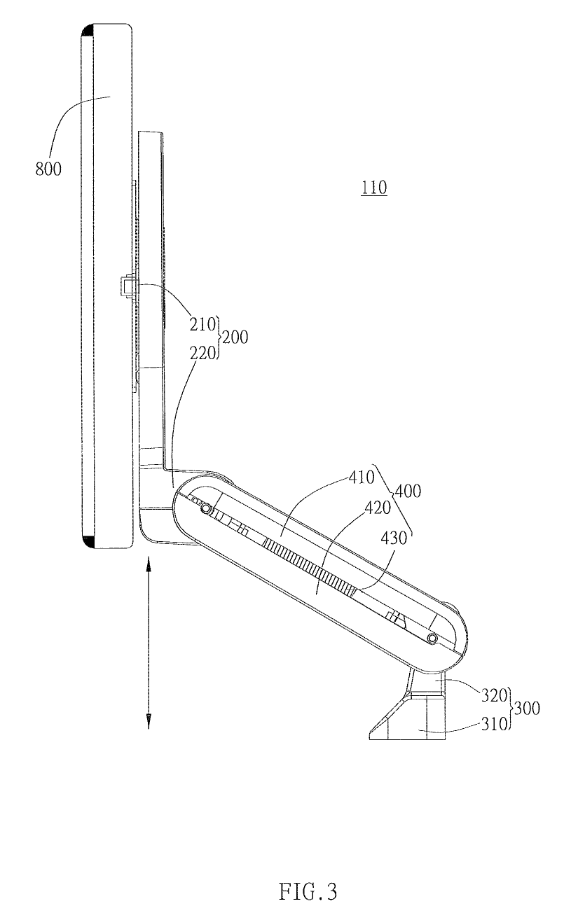

FIG. 3 is a side view of the display device 110 of the present invention, wherein the display device 110 includes a display panel 800 and a height-adjustable apparatus 100. Furthermore, the display panel 800 is a liquid crystal display panel, but is not limited thereto; in different embodiments, the display panel 800 can include other flat display panels such as an organic light emitting diode display panel. The height-adjustable apparatus 100 illustrated in FIG. 3 is substantially identical to the height-adjustable apparatus 100 illustrated in FIG. 2A and FIG. 2B and related descriptions will not be elaborated here.

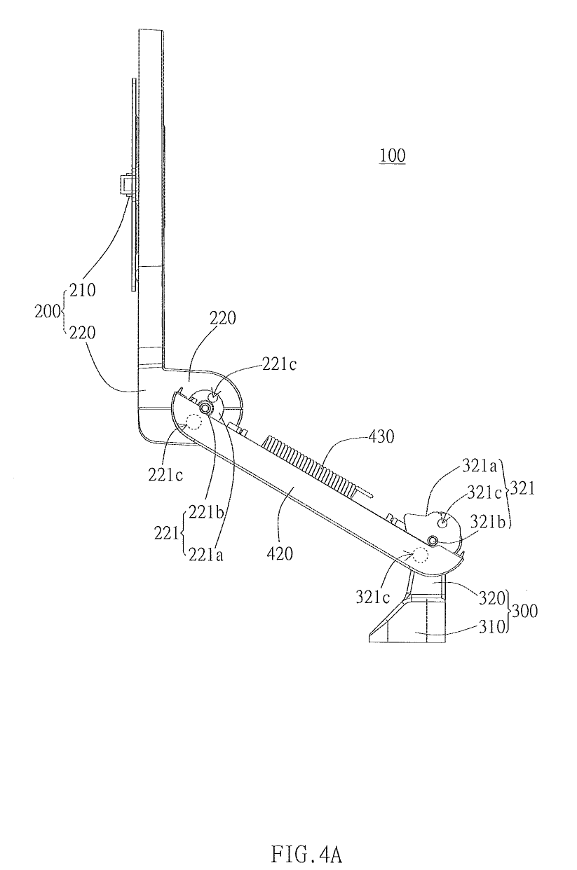

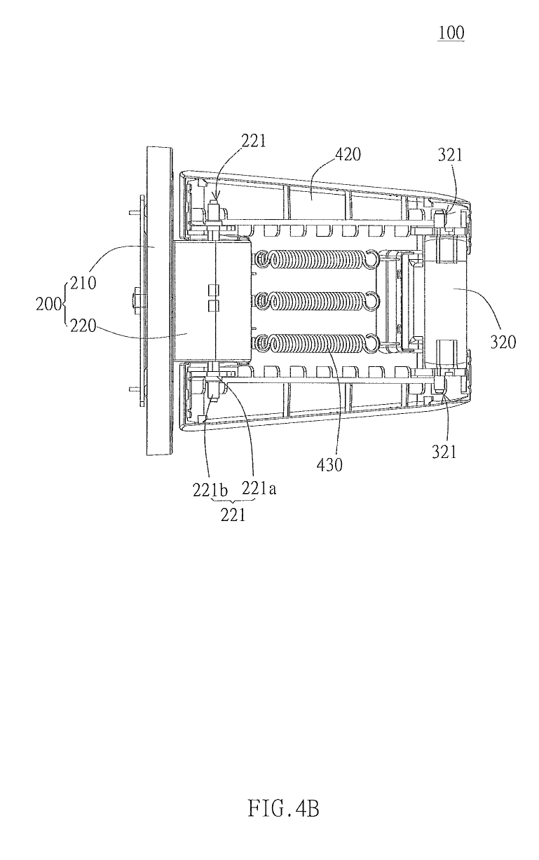

FIG. 4A and FIG. 4B are respectively a side view and a top view of the height-adjustable apparatus 100 of the present invention, wherein the first cover is omitted in FIG. 4A and FIG. 4B. As FIG. 4A and FIG. 4B show, the connector 220 includes a first pivot set 221, wherein the first cover (not illustrated) and the second cover 420 are connected pivotally to different sections of the first pivot set 221. The first pivot set 221 includes a first disc 221a and a first arm 221b, wherein different sections of the first disc 221a is connected to the first cover and the second 420 respectively and rotate with respect to the first arm 221b. That is, the first arm 221b is the centre of rotation. The first disc 221a further includes two first pivot openings 221c for a shaft to pass through the second coupling portion 417 of the first cover, the fourth coupling portion 427 of the second cover 420 (see FIG. 2A) and the first pivot opening 221c to couple the connector coupling portion 220 with the first cover and the second cover 420 (Please also refer to FIG. 2A). In the present embodiment, the first pivot openings 221c are formed on two opposite sides with respect to the first arm 221b, but are not limited thereto. The first arm 221b is disposed between the first cover and the second cover 420. Furthermore, the first disc 221a is connected to the connector coupling portion 220 and thus the first arm 221b connected to the first disc 221a can rotate together with the first disc 221a.

In the embodiment illustrated in FIG. 4A and FIG. 4B, the supporting unit 400 further includes an elastic element 430 disposed between the first cover and the second cover 420, wherein the elastic element 430 is a spring disposed between the space enclosed between the assembled first cover and second cover 420. Two ends of the elastic element 430 are connected respectively with the inner surfaces of the first cover and the second cover 420, but are not limited thereto; in different embodiments, the supporting unit 400 can include other types of elastic element 430. The elastic element 430 is used to regulate the movement of the first cover and that of the second cover 420 relative to each other in order to control the moving speed and the moving range of the connector 200.

Similarly, in the embodiment illustrated in FIG. 4A and FIG. 4B, the base coupling portion 320 includes a second pivot set 321 for coupling with the first cover and the second cover 420. As FIG. 4A and FIG. 4B show, the first cover and the second cover 420 are assembled to enclose the first pivot set 221 and the second pivot set 321, but are not limited thereto; in different embodiments, the design of the first cover and the second cover 420 can be modified to cover at least part of the base coupling portion 320 and at least part of the connector coupling portion 220. The second pivot set 321 is used to couple the base coupling portion 320 pivotally with the first cover and the second cover 420. The second pivot set 321 includes a second disc 321a and a second arm 321b. Furthermore, the second disc 321a includes two second pivot openings 321c for a shaft to pass through the first coupling portion 416 of the first cover (see FIG. 2A), the third coupling portion 426 of the second cover 420 and the second pivot opening 321c to couple the base coupling portion 320 with the first cover and the second cover 420. Furthermore, the elements and the structure of the second pivot set 321 are substantially identical to those of the first pivot set 221 and will not be elaborated here.

In the embodiment illustrated in FIG. 4A and FIG. 4B, different parts of the first pivot set 221 of the connector coupling portion 220 are connected to the first cover and the second cover 420, respectively. Similarly, different parts of the second pivot set 321 are connected to the first cover and the second cover 420, respectively. In other words, two ends of the first cover and those of the second cover 420 are pivotally connected to the connector coupling portion 220 and the base coupling portion 320. The first cover and the second cover 420 together form a closed loop or four-bar linkage. In this way, after the connector coupling portion 220 and the base coupling portion 320 are connected to the first cover and the second cover 420, the first cover and the second cover 420 can be subject to an external force and move in opposite directions relative to each other. The connector 200 or the base 300 can drive the first cover and the second cover 420 to reciprocally move in corresponding directions when subjected to an external force.

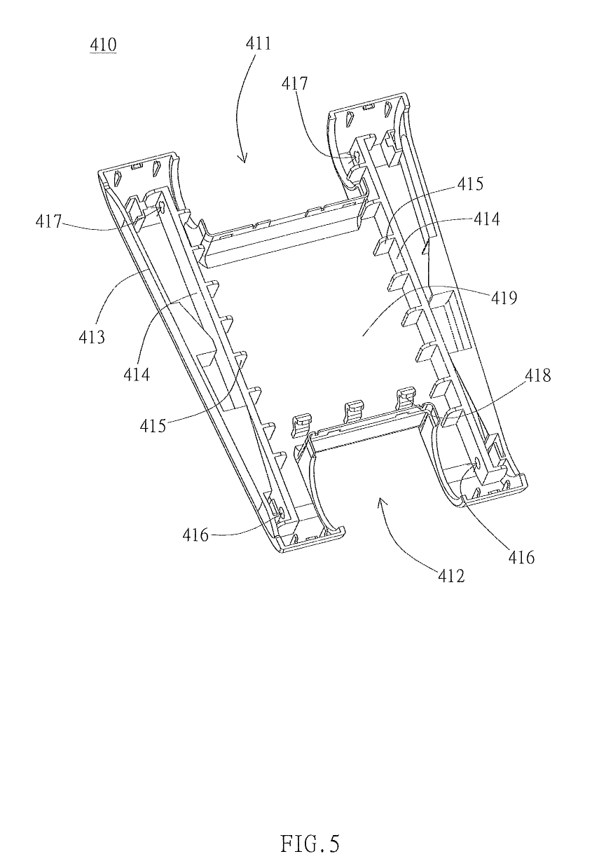

FIG. 5 is a schematic view illustrating the inner surface of the first cover 410 of the present invention, wherein the first cover 410 includes a first connector space 411 and a first base space 412 located on two opposite ends of the first cover 410. At least part of the connector coupling portion 220 and part of the base coupling portion 320 illustrated in FIG. 3 are disposed in the first connector space 411 and the first base space 412, respectively. In the present embodiment, the first cover 410 includes a first inner surface 419, a first curved portion 413, and a first rib 414, wherein the first curved portion 413 is formed along the edge of the first cover 410. The first rib 414 is configured to increase the structural strength of the first cover 410 to withstand external stress applied on the first cover 410. The first rib 414 is disposed on the first inner surface 419 near the first connector space 411 and extends therefrom towards the first base space 412. Furthermore, the first cover 410 of the present embodiment includes a plurality of first reinforcing ribs 415 formed on the first inner surface 419 for enhancing the structure of the first cover 410. In the present embodiment, the first reinforcing rib 415 is connected to and extends in a direction perpendicular to the extending direction of the first rib 414, but is not limited thereto. In different embodiments, the first reinforcing rib 415 can be disposed at other suitable locations of the first cover 410. The first reinforcing rib 415 of the present embodiment is disposed on the first inner surface 419 between two first ribs 414, but is not limited thereto; in different embodiments, two ends of the first reinforcing rib 415 can be disposed on the first inner surface 419, wherein two ends of the first reinforcing rib 415 are connected to the first rib 414 and the first curved portion 413, respectively.

As FIG. 5 shows, the first cover 410 further includes a first coupling portion 416 for a shaft (not illustrated) to pass through to couple the first coupling portion 416 with the first pivot set 221 in FIG. 4A. Similarly, the first cover 410 includes a second coupling portion 417 for another shaft to pass through to couple the second coupling portion 417 with the second pivot set 321 in FIG. 4A. In the present embodiment, the first coupling portion 416 and the second coupling portion 417 are formed near two ends of the first rib 414 and are located near the first connector space 411 and the first base space 412, but are not limited thereto. In different embodiments, the first coupling portion 416 and the second coupling portion 417 can be disposed on the inner surface of the first curved portion 413 facing the first connector space 411 and the first base space 412 or other suitable positions. As FIG. 5 shows, the first cover 410 includes a first hook 418 on the first inner surface 419 for coupling with the elastic element 430 illustrated in FIG. 4B. In the present embodiment, the first hook 418 is disposed on the inner surface of the first cover 410 near the first base space 412, but is not limited thereto. Furthermore, as FIG. 5 shows, the first rib 414 and the first reinforcing rib 415 protrude from a direction substantially perpendicular to the first inner surface 419. In this way, the first coupling portion 416 and the second coupling portion 417 can be considered as being integrally formed with the first cover 410 protruding outside the first inner surface 419.

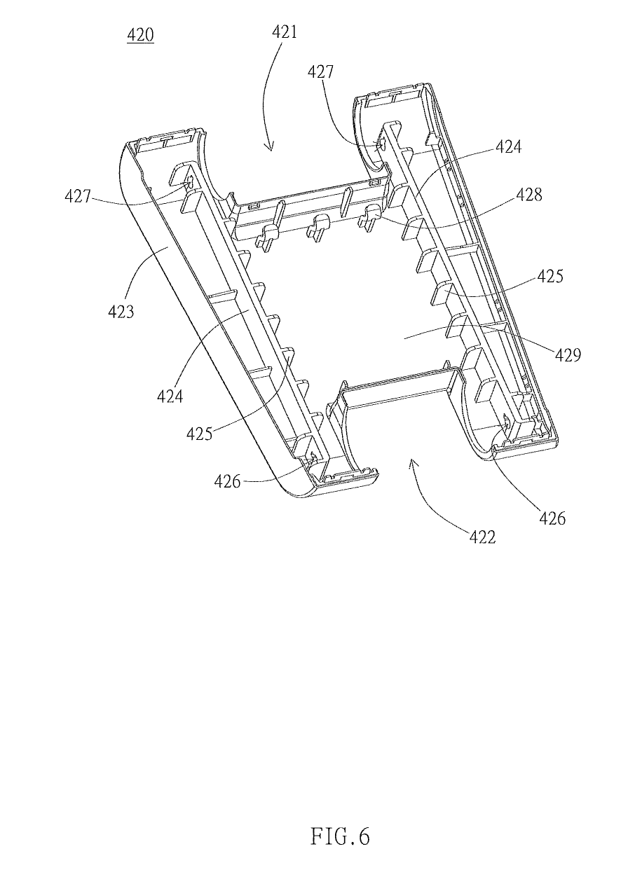

FIG. 6 is a schematic view of the second cover 420 illustrated in FIG. 2A, wherein the second cover 420 includes a second connector space 421 and a second base space 422 located on two opposite ends of the second cover 420. The first connector space 411 (see FIG. 5) and the second connector space 421 are combined to accommodate at least part of the connector coupling portion 220. The first base space 412 (see FIG. 5) and the second base space 422 are combined to accommodate at least part of the base coupling portion 320. Furthermore, the second cover 420 includes a second inner surface 429, a second curved portion 423, and a second rib 424, wherein the second curved portion 423 is formed along the edge of the second cover 420. In other words, the first curved portion 413 and the second curved portion 423 correspond to each other to include a space between the first cover 410 and the second cover 420 and to also cover part of the connector coupling portion 220 and part of the base coupling portion 320. The second rib 424 is disposed on the second inner surface 429 for strengthening the structure of the second cover 420 to against possible external stresses exerted on the second cover 420. The second rib 424 of the present embodiment is disposed on the second cover 420 and extends from the second base space 422 linearly toward the second connector space 421. Furthermore, the second cover 420 further includes a plurality of second reinforcing ribs 425 disposed on the inner surface of the second cover 420 and connected to the second ribs 424, wherein the second reinforcing ribs 425 are perpendicular to the second ribs 424. Furthermore, in different embodiments, two ends of the second reinforcing ribs 425 can be connected to the second rib 424 and the second curved portion 423, respectively.

As FIG. 6 shows, the second cover 420 further includes a third coupling portion 426 for a shaft (not illustrated) to pass through to couple the third coupling portion 426 with the second pivot set 321 of the base coupling portion 320. Similarly, the second cover 420 also includes a fourth coupling portion 427 for another shaft to pass through to couple the fourth coupling portion 427 with the second pivot set 321 of the connector coupling portion 320. The third coupling portion 426 and the fourth coupling portion 427 are formed near two ends of the second rib 424 and are located near the second connector space 421 and the second base space 422, but are not limited thereto. Furthermore, as FIG. 6 shows, the second rib 424 and the second reinforcing rib 425 protrude from a direction substantially perpendicular to the second inner surface 429. In this way, the third coupling portion 426 and the fourth coupling portion 427 can be regarded as being integrally formed to protrude outside the second inner surface 429 of the second cover 420.

In the embodiment illustrated in FIG. 6, the second cover 420 further includes a second hook 428 disposed on the inner surface of the second cover 420 for coupling with one end of the elastic element 430 illustrated in FIG. 4A. In the present embodiment, the second hook 428 is located on the inner surface of the second cover 420 near the second connector space 421, but is not limited thereto. In different embodiments, the second hook 428 can be selectively disposed on the inner surface of the first cover corresponding to the second base space 422. Furthermore, two ends of the elastic element 430 are coupling with the first hook 418 and the second hook 428, wherein the first hook 418 and the second hook 428 of the present embodiment are disposed on the inner surface of the first cover 410 near the first base space 412 and on the inner surface of the second cover 420 near the second connector space 421, respectively.

Furthermore, in the embodiment illustrated in FIG. 5 and FIG. 6, the connector coupling portion 220 illustrated in FIG. 4 is connected to the first cover 410 and the second cover 420 and exposed from the first connector space 411 and the second connector space 421, but is not limited thereto. In different embodiments, the first curved portion 413 and the second curved portion 423 are designed to at least partly cover the connector coupling portion 220. Similarly, in different embodiments, the first curved portion 413 and the second curved portion 423 are designed to at least partly cover the base coupling portion 320. Furthermore, at least part of the connector coupling portion 220 and the base coupling portion 320 are located in the space enclosed by the assembled first cover 410 and second cover 420.

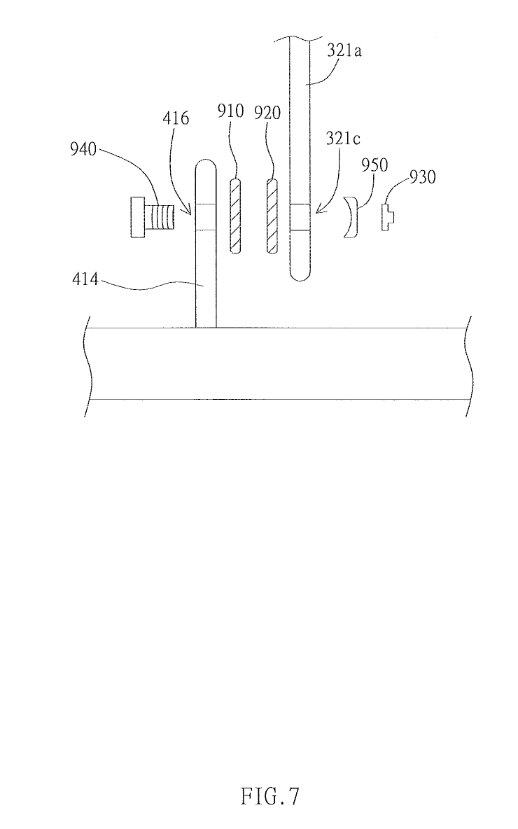

FIG. 7 is a partial cross-sectional view of the height-adjustable display, wherein a pivot set is used to couple the first coupling portion 416 with the second pivot opening 321c of the base coupling portion. The pivot set includes a first washer 910, a second washer 920, a first screw element 930, a second screw element 940 and an elastic pad 950. As FIG. 7 shows, the pivot set couples the first coupling portion 416 of the first cover rotatably with the pivot opening 321c of the base coupling portion 320. The second screw element 940 pass through the first coupling portion 416 and the second pivot opening 321c to couple with the first screw element 930. In this way, the first screw element 930 and the second screw element 940 rotatably couple the first washer 910, the second washer 920 and the elastic pad 950 with the first coupling portion 417 and the second pivot opening 321c of the second disc 321a. The first washer 910 and the second washer 920 are used to provide friction for controlling the rotation rate of the pivot set. The elastic pad 950 is used to provide a normal force for controlling the coupling strength between the pivot set and the first rib 414 as well as the second disc 321a illustrated in FIG. 2A. Similarly, the pivot set is used to couple the first coupling portion of the first cover illustrated in FIG. 5 with the first pivot opening 221c of the connector coupling portion 221 illustrated in FIG. 4B.

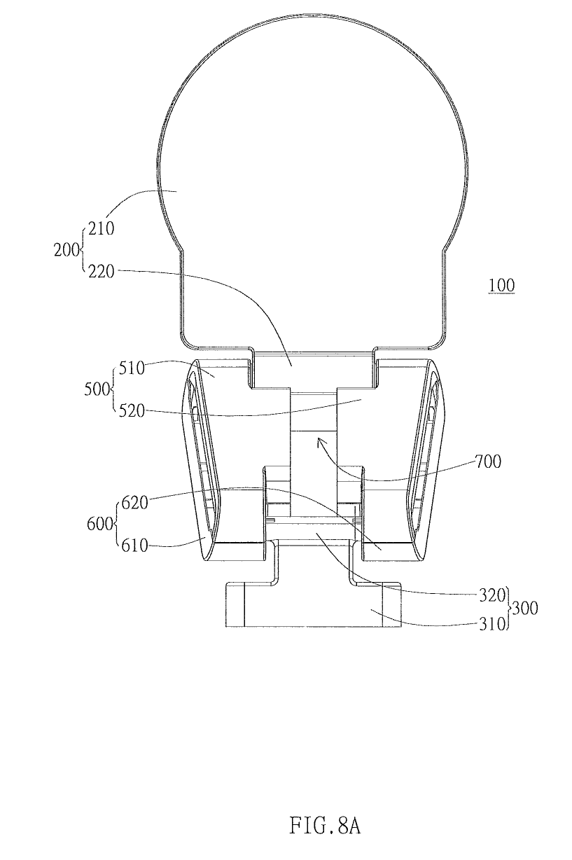

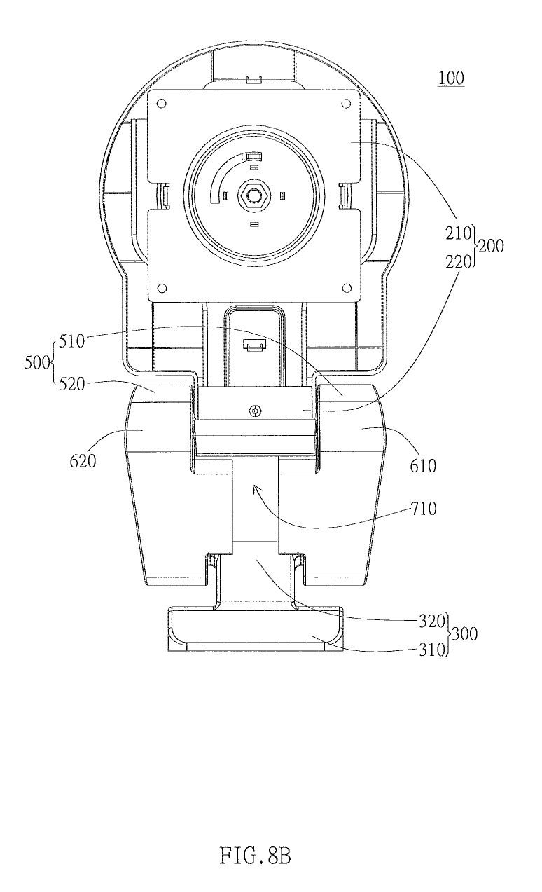

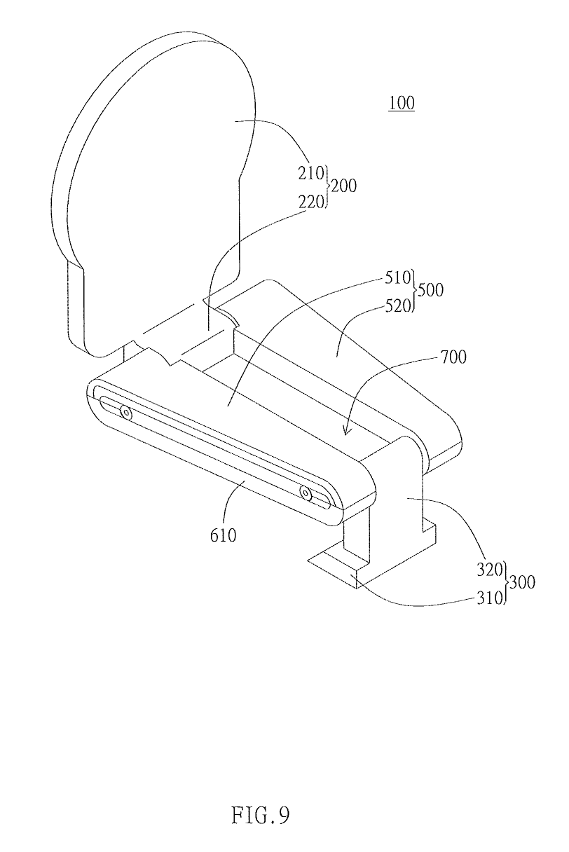

FIG. 8A, FIG. 8B and FIG. 9 are a top view, a back view and a schematic view illustrating a variation of the height-adjustable apparatus 100. The height-adjustable apparatus 100 includes a first main cover 500 and a second main cover 600, wherein the first main cover 500 includes a first sub-cover 510 and a second sub-cover 520 while the second cover 600 includes a third sub-cover 610 and a fourth sub-cover 620. As FIG. 8A shows, the connector 200 of the present embodiment is substantially identical to the connector 200 illustrated in FIG. 2A and is not elaborated hereinafter. Two ends of the first sub-cover 510 are connected to one end of the base coupling portion 320 and to one end of the connector coupling portion 220, respectively. Two ends of the second sub-cover 520 are each connected to another end of the base coupling portion 320 and another end of the connector coupling portion 220, respectively. A first gap 700 is formed between the first sub-cover 510 and the second sub-cover 520. As FIG. 8B shows, two ends of the third sub-cover 610 are connected to one end of the base coupling portion 320 and one end of the connector coupling portion 220, respectively. Two ends of the fourth sub-cover 620 are connected to another end of the base coupling portion 320 and another end of the connector coupling portion 220, respectively. Similarly, in the embodiment illustrated in FIG. 8B, a second gap 710 is formed between the third sub-cover 610 and the fourth sub-cover 620.

In the embodiment illustrated in FIG. 8A and FIG. 8B, a space is enclosed between the assembled first main cover 500 and second main cover 600 for accommodating elastic element such as spring or other elements. Furthermore, the first main cover 500 and the second main cover 600 of the present embodiment are made of plastic materials, wherein the above-mentioned plastic materials may include materials with extensibility greater than 5% such as polyvinyl chloride or other suitable materials. In the present embodiment, the first main cover 500 and the second main cover 600 are manufactured through injection molding, but are not limited thereto; in different embodiments, the first main cover 500 and the second main cover 600 can be manufactured through other molding methods. Furthermore, the first main cover 500 consists of two separate first sub-cover 510 and second sub-cover 520, wherein a gap 700 is kept between the sub-covers 510, 520 and a combination of the first sub-cover 510 and the first sub-cover 610 is substantially parallel to a combination of the second sub-cover 520 and second sub-cover 620. The above-mentioned structure will reduce the amount of materials used for making the first main cover 500 and the overall cost for manufacturing the height-adjustable apparatus of the present invention. Similarly, the structure of the second main cover 600 also consists of two separate sub-covers including the first sub-cover 610 and the second sub-cover 620 to reduce the amount of materials for making the second main cover 600 and the overall costs for manufacturing the height-adjustable apparatus.

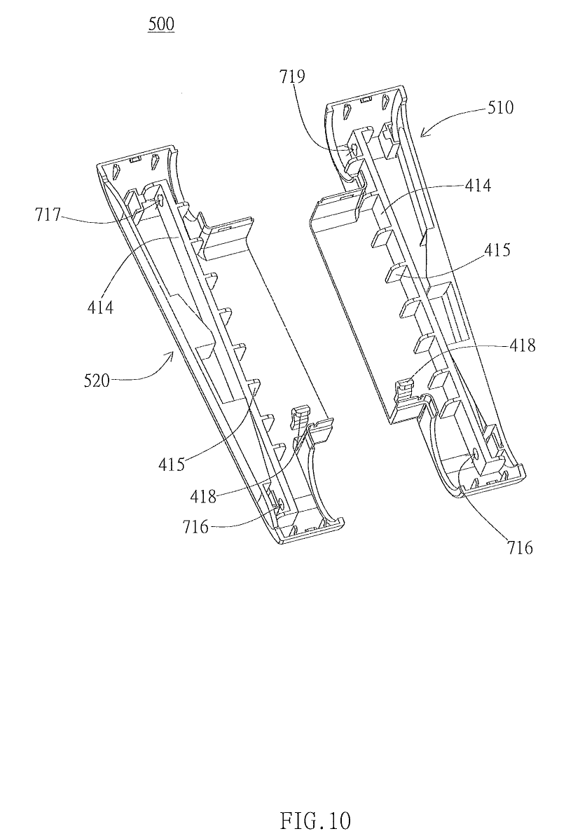

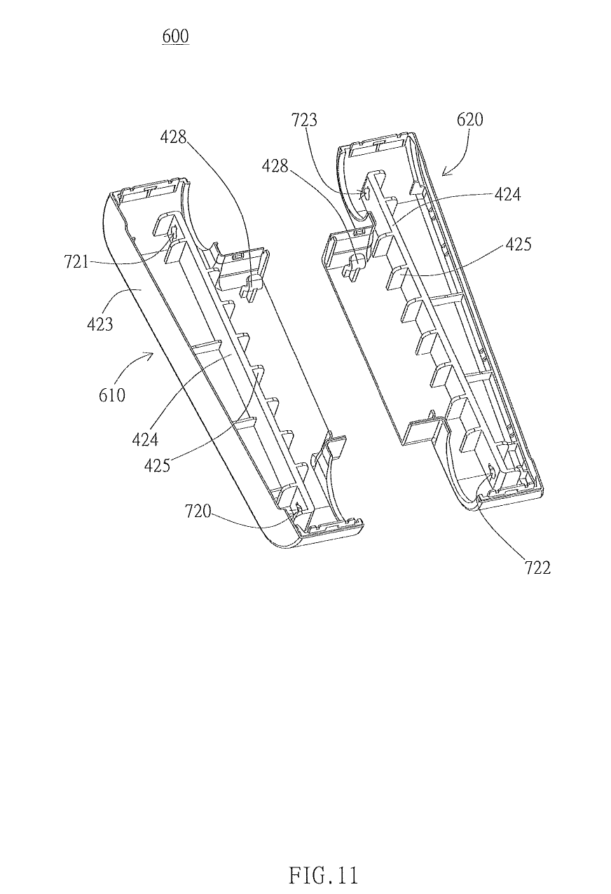

FIG. 10 is a schematic view illustrating the first sub-cover 510 and the second sub-cover 520 illustrated in FIG. 8A. FIG. 11 is a schematic view illustrating the third sub-cover 610 and the fourth sub-cover 620 illustrated in FIG. 8B. As FIG. 10 and FIG. 11 show, the first sub-cover 510 and the second sub-cover 520 are symmetric while the third sub-cover 610 and the fourth sub-cover 620 are symmetric. The inner surface of the first sub-cover 510 and that of the second sub-cover 520 are each disposed with a first rib 414, a first reinforcing rib 415 and a first hook 418. The inner surface of the third sub-cover 610 and that of the fourth sub-cover 620 are each disposed with a second rib 424, a second reinforcing rib 425 and a second hook 428. The structure and the elements of the first main cover 500 and the second main cover 600 of the present embodiment are substantially identical to those of the first cover 410 and the second cover 420 illustrated in FIG. 2A and are not elaborated hereinafter. Furthermore, as FIG. 10 shows, the first ribs 414 and the first reinforcing ribs 415 are substantially perpendicular to the inner surface of the first sub-cover 510 and that of the second sub-cover 520. Similarly, the second ribs 424 and the second reinforcing ribs 425 are substantially perpendicular to the inner surface of the third sub-cover 610 and that of the fourth sub-cover 620.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A height-adjustable apparatus, comprising:
a connector having a connector coupling portion;
a base having a base coupling portion; and
a supporting unit including:
a first cover integrally formed with a first coupling portion and a second coupling portion, wherein the first coupling portion is pivotally connected to the base coupling portion and the second coupling portion is pivotally connected to the connector coupling portion; and
a second cover integrally formed with a third coupling portion and a fourth coupling portion, wherein the third coupling portion is pivotally connected to the base coupling portion and the fourth coupling portion is pivotally connected to the connector coupling portion;
wherein the first cover and the second cover, the first coupling portion and the second coupling portion are assembled to form a space therein, the second coupling portion, the third coupling portion and the fourth coupling portion are located within the space.

2. The height-adjustable apparatus of claim 1, wherein a material of the supporting unit comprises plastic materials.

3. The height-adjustable apparatus of claim 1, wherein the first cover further comprises a first curved portion disposed along an edge of the first cover and extending towards the second cover, the second cover comprises a second curved portion disposed along an edge of the second cover and extending towards the first cover, the space is enclosed in the assembled first curved portion and second curved portion.

4. The height-adjustable apparatus of claim 1, wherein at least part of the base coupling portion and at least part of the connector coupling portion extend into the space and are covered by the assembled first cover and the second cover.

5. The height-adjustable apparatus of claim 4, wherein the base coupling portion has a first pivot set for movably coupling with the first cover, the connector coupling portion has a second pivot set for movably coupling with the second cover, the first pivot set and the second pivot set are covered by the assembled first cover and second cover.

6. The height-adjustable apparatus of claim 1, wherein the first coupling portion, the second coupling portion, the third coupling portion, and the fourth coupling portion are openings, the base coupling portion has a first pivot set and the connector coupling portion has a second pivot set, the first pivot set and the second pivot set coupled with the openings.

7. The height-adjustable apparatus of claim 1, further comprising an elastic element, wherein one end of the elastic element is coupled with the first cover while the other end of the elastic element is coupled with the second cover.

8. The height-adjustable apparatus of claim 1, wherein the first cover has a first inner surface and a first rib extending from the first inner surface towards the second cover, the second cover has a second inner surface and a second rib extending from the second inner surface towards the first cover, the first coupling portion is disposed at one end of the first rib while the second coupling portion is disposed at the other end of the first rib.

9. The height-adjustable apparatus of claim 8, further comprising an elastic element, wherein the first cover comprises a first hook disposed on the first inner surface and the second cover comprises a second hook disposed on the second inner surface of the second cover, two ends of the elastic element are coupled with the first hook and the second hook, respectively.

10. The height-adjustable apparatus of claim 9, wherein the first rib extends from the first coupling portion towards the second coupling portion, the second rib extends from the third coupling portion towards the fourth coupling portion.

11. The height-adjustable apparatus of claim 10, wherein the first cover has a first reinforcing rib extending from the first inner surface towards the second cover and perpendicular to the first rib, the second cover further comprises a second reinforcing rib extending from the second inner surface towards the first cover and perpendicular to the second rib.

12. A height-adjustable apparatus, comprising:
a connector having a connector coupling portion;
a base having a base coupling portion; and
a supporting unit comprising:
a first main cover comprising:
a first sub-cover integrally formed with a first coupling portion and a second coupling portion pivotally connected to the base coupling portion and the connector coupling portion, respectively; and
a second sub-cover integrally formed with a third coupling portion and a fourth coupling portion pivotally connected to the base coupling portion and the connector coupling portion respectively; and
a second main cover, wherein two ends of the second cover are coupled with the base coupling portion and the connector coupling portion, respectively;
wherein the first sub-cover, the second sub-cover and the second main cover are combined to form a space therein, a first gap is formed between the first sub-cover and the second sub-cover; the first coupling portion, the second coupling portion, the third coupling portion, and the fourth coupling portion are located in the space.

13. The height-adjustable apparatus of claim 12, wherein the second main cover comprises:
a third sub-cover having a fifth coupling portion and a sixth coupling portion for pivotally coupling with the base coupling portion and the connector coupling portion, respectively; and
a fourth sub-cover having a seventh coupling portion and an eighth coupling portion for pivotally coupling with the base coupling portion and the connector coupling portion, respectively;
wherein a second gap is formed between the third sub-cover and the fourth sub-cover, the fifth coupling portion, the sixth coupling portion, the seventh coupling portion, and the eighth coupling portion are disposed in the space.

14. A display apparatus, comprising:
a panel;
a connector having a connector coupling portion, the panel coupling to the connector;
a base having a base coupling portion;
a first cover having a first hook disposed on an inner surface of the first cover, a first end of the first cover pivotally connecting to the base coupling portion and a second end of the first cover pivotally connecting to the connector coupling portion;
a second cover having a second hook disposed on an inner surface of the second cover, a third end of the second cover pivotally connecting to the base coupling portion and a fourth end of the second cover pivotally connecting to the connector coupling portion; and
an first elastic element disposed between the first cover and the second cover, the first elastic element connecting the first hook and the second hook.

15. The display apparatus of claim 14, the first cover further comprising:
a first rib extending from the first inner surface towards the second cover; and
a plurality of reinforcing ribs disposed on the first inner surface and connecting to the first rib,

16. the display apparatus of claim 14, wherein the first rib is perpendicular to at least one of the reinforcing ribs.

17. the display apparatus of claim 14, wherein the first rib is connecting to the connector coupling portion and the base coupling portion.

18. the display apparatus of claim 14, further comprising:
a third cover having a third hook disposed on an inner surface of the third cover, a first end of the third cover pivotally connecting to the base coupling portion and a second end of the third cover pivotally connecting to the connector coupling portion;
a fourth cover having a fourth hook disposed on an inner surface of the fourth cover, a third end of the fourth cover pivotally connecting to the base coupling portion and a fourth end of the fourth cover pivotally connecting to the connector coupling portion; and
an second elastic element disposed between the third cover and the fourth cover, the elastic element connecting the third hook and the fourth hook, wherein a combination of the first cover and the second cover is substantially parallel to a combination of the third cover and the fourth cover.

19. The display apparatus of claim 18, wherein the connector, the base, the combination of the first cover and the second cover and the combination of the third cover and the fourth cover form a gap.

20. The display apparatus of claim 14, the first cover having a plurality of first hooks disposed on the inner surface of the first cover and the second cover having a plurality of second hooks disposed on the inner surface of the second cover, the display apparatus further comprising:
a plurality of first elastic elements disposed between the first cover and the second cover, each of the first elastic element connecting one of the first hooks and one of the second hooks respectively.
